(19) United States
(12) Patent Application Publication
(10) Pub. No.: US 2025/0161736 A1
(43) Pub. Date: May 22, 2025

(54) BUCKLE CONNECTOR AND CHEST EXPANDER USING THE SAME

(71) Applicant: HangZhou YuShu TECHNOLOGY CO.,LTD., Zhejiang (CN)

(72) Inventor: Xingxing Wang, Zhejiang (CN)

(21) Appl. No.: 18/728,311

(22) PCT Filed: Mar. 17, 2022
(86) PCT No.: PCT/CN2022/081509

§ 371 Date: Jan. 31, 2025

(30) Foreign Application Priority Data
Jan. 14, 2022 (CN) 202220100405.2

(51) Int. Cl. A63B 21/055; F16G 11/10

(52) U.S. Cl. CPC A63B 21/0557; F16G 11/105

(57) ABSTRACT

A buckle connector and a chest expander using the same. The buckle connector includes a male buckle (1) and a female buckle (2) fit with each other. The male buckle (1) includes a connecting portion (11). The connecting portion (11) includes a clamping member (13). The female buckle (2) is provided with an opening (21) for inserting the clamping member (13). The opening (21) extends towards the interior of the female buckle (2) and forms a groove (22) for accommodating the clamping member (13) along a circumferential direction. An elastic member is provided in the groove (22). A protruding portion (24) for preventing the clamping member (13) from passing through is provided on the elastic member. When a torque is applied to the male buckle (1) so that the clamping member (13) rotates in the groove (22) and passes through the protruding portion (24), the clamping member (13) squeezes the protruding portion (24) and causes the protruding portion (24) to retreat to allow the clamping member (13) to pass through. After the clamping member (13) passes through the protruding portion (24), the protruding portion (24) returns to a position before squeezed. In the buckle connector, the male buckle (1) is inserted into the female buckle (2) from the opening (21), and then the male buckle (1) is rotated, so that the clamping member (13) rotates in the groove (22), and thus the clamping member (22) is clamped by means of the horizontal groove in the female connector, achieving the effect of connecting the male buckle (1) and the female buckle (2) conveniently and easily.

### TECHNICAL FIELD

The present utility model relates to a buckle connector and a chest expander using the same, belonging to the technical field of buckles.

### BACKGROUND

A buckle is a mechanism used for embedded connection or overall locking between one component and another. The characteristics of buckle connection include convenience in assembly and disassembly, and tool-free disassembly. However, the existing buckle structure has defects and poor stability. The buckle falls off easily during use, especially in scenarios where the force is uneven, the magnitude of the force is not fixed, and the direction of the force changes. Therefore, a buckle which is stable and reliable in connection and convenient to disassemble is needed.

Further, Chinese patent (CN211117028U) discloses a quick-release buckle assembly, which includes a male part and a female part. The female part is provided a through-connection hole. The male part is provided with a through-connection shaft which is inserted into the through-connection hole and can be clamped with the through-connection hole after rotation. The through-connection hole is circular, and an opening edge of the through-connection hole is provided with a first limiting protrusion facing to a center of the through-connection hole. A surface of the through-connection shaft is provided with a second limiting protrusion. The groove is provided in a surface of the second limiting protrusion. After the second limiting protrusion passes through the through-connection hole, rotating the male part can make the second limiting protrusion align with the first limiting protrusion to achieve clamping. The second limiting protrusion is provided a clamping hook fit with an edge of the first limiting protrusion. The clamping hook is used to achieve clamping with the first limiting protrusion to limit the rotation of the male part relative to the female part.

### SUMMARY

### Technical Problem

The above solution achieves clamping with the first limiting protrusion through the clamping hook to limit the rotation of the male part relative to the female part. However, the structural strength of the clamping hook is relatively low, and it is easy to wear or damage after repeated use, thus losing the limiting effect, affecting the service life of the buckle connector and influencing promotion and use.

### Solution to Problem

### Technical Solution

In order to overcome the defects of the existing technology, a first purpose of the present utility model is to provide a buckle connector, which is stable and reliable in connection, and convenient and simple to separate.

A second purpose of the present utility model is to provide a buckle connector. At least one clamping member is provided on a male buckle of the buckle connector. A female buckle of the buckle connector is provided with an opening for inserting the clamping member and a groove for allowing the clamping member to rotate. An elastic member is provided in the groove. A protruding portion is provided on the elastic member. When the clamping member rotates in the groove and passes through the protruding portion, it squeezes the protruding portion and then enters the groove, and then the protruding portion returns to an original position. In a case that no torque is applied externally to the male buckle, the protruding portion can prevent the clamping member from rotating in the groove, so that the connection between the male buckle and the female buckle is stable and reliable. The solution is simple, practical and feasible, and facilitates the production, manufacturing, promotion and use.

A third purpose of the present utility model is to provide a chest expander. The chest expander and accessories are connected through the buckle connector, thus facilitating the replacement and connection of various accessories. It is stable and reliable in connection, and convenient and simple to separate.

In order to achieve the first purpose, the present utility model adopts a first technical solution as follows:

A buckle connector, including a male buckle and a female buckle fit with each other, the male buckle including a connecting portion, the connecting portion including a clamping member; the female buckle being provided with an opening for inserting the clamping member, the opening extending towards the interior of the female buckle and forming a groove for accommodating the clamping member along a circumferential direction, an elastic member being provided in the groove, a protruding portion for preventing the clamping member from passing through being provided on the elastic member; when the clamping member rotates in the groove and passes through the protruding portion, the clamping member squeezing the protruding portion and causing the protruding portion to retreat to allow the clamping member to pass through; after the clamping member passes through the protruding portion, the protruding portion returning to a position before squeezed.

During use of the buckle connector provided in the present utility model, the male buckle is inserted into the female buckle from the opening, then the male buckle or female buckle is rotated to cause the clamping member to rotate in the groove, and then the clamping member is clamped through the horizontal groove in the female buckle, thus connecting the male buckle with the female buckle and achieving connection conveniently and easily. Since the elastic member is provided in the groove and the protruding portion is provided on the elastic member, when the clamping member rotates in the groove and passes through the protruding portion, it squeezes the protruding portion and then enters the groove, and then the protruding portion returns to an original position. In a case that no torque is applied externally to the male buckle, the protruding portion can prevent the clamping member from rotating in the groove, so that the connection between the male buckle and the female buckle is stable and reliable. When the buckle connector needs to be unfastened, a torque is applied to the male buckle to cause the clamping member to squeeze the protruding portion, so that the male buckle is separated from the female buckle. It is simple and rapid to separate, and is time-saving and labor-saving.

As an exemplary technical solution, the elastic member is an elastic sheet, one end of the elastic sheet is fixed at a bottom of the groove, and the other end is a free end; the protruding portion is provided at the free end of the elastic sheet; when the clamping member squeezes the protruding portion, the protruding portion retreats; after the clamping member passes through the protruding portion, the protruding portion returns to the position before squeezed under the action of the elastic sheet. By providing the elastic sheet at the bottom of the groove to achieve the function of the elastic member, the structure is simple and the cost is low.

As an exemplary technical solution, a protrusion is provided in the opening, a recess fit with the protrusion is provided on the connecting portion, and the protrusion is abutted against the recess when the connecting portion is inserted into the opening. By providing the protrusion and the recess fit with each other, the structure of the female buckle can be prevented from being damaged because the force in the axial direction is too large when the male buckle is inserted into the female buckle.

As an exemplary technical solution, the connecting portion includes an insertion head, the clamping member is cylindrical, the clamping member is symmetrically provided at the end of the insertion head, and the opening is in a shape fit with the connecting portion. Since the clamping member is cylindrical, it is easier and more labor-saving when it passes through the protruding portion. Since the clamping member is symmetrically provided on the insertion head, the stress is more even during the connection between the male buckle and the female buckle.

As an exemplary technical solution, the male buckle further includes a fixed portion fixedly connected with the connecting portion, and the fixed portion is provided with a through hole for fixing parts such as pull ropes.

The shape of the main body of the male buckle and the female buckle may be a shape of a columnar body, a shape of a columnar or cubic body after local cutting, a shape of a cubic body after chamfering treatment, or any other irregular shape.

In order to achieve the second purpose, the present utility model adopts a second technical solution as follows:

A buckle connector, including a male buckle and a female buckle rotatable relative to each other;
at least one clamping member being provided on the male buckle;
the female buckle being provided with an opening for inserting the clamping member and a groove for allowing the clamping member to rotate;
an elastic member being provided in the groove;
a protruding portion for limiting the clamping member being provided on the elastic member;
when a torque is applied to the male buckle so that the clamping member rotates in the groove and passes through the protruding portion, the clamping member squeezing the protruding portion and causing the protruding portion to retreat to allow the clamping member to pass through;
after the clamping member passes through the protruding portion, the protruding portion returning to a position before squeezed to complete the operation of locating the male buckle on the female buckle.

In the present utility model, after continuous exploration and experimentation, a buckle connector is provided. The male buckle is inserted into the female buckle from the opening, and then the male buckle or the female buckle is rotated to cause the clamping member to rotate in the groove. Since the elastic member is provided in the groove and the protruding portion is provided on the elastic member, when the clamping member rotates in the groove and passes through the protruding portion, it squeezes the protruding portion and enters the groove, and then the protruding portion returns to an original position. In a case that no torque is applied externally to the male buckle, the protruding portion can prevent the clamping member from rotating in the groove, so that the connection between the male buckle and the female buckle is stable and reliable. The solution is simple, practical and feasible, and facilitates the production, manufacturing, promotion and use.

As an exemplary technical solution,
the clamping member is a cylindrical or spherical structure or a square structure subjected to chamfering treatment, and extends outwards from a main body of the male buckle to form a protruding wing-shaped body;
the number of the clamping member may be one, two, or three, which may be selected by those skilled in the art according to the actual situation;
the opening is in a shape fit with the shape of the clamping member.

As an exemplary technical solution,
the groove is provided with a recessed portion at a position fit with the protruding portion;
the recessed portion is provided on a bottom wall or side wall of the groove, is provided with the elastic member inside, is capable of accommodating the protruding portion, and forms a retreating space for the protruding portion, so the structure is simple and practical, and the solution is feasible;
the elastic member is a spring, a rubber body, a torsion spring, or an elastic sheet.

As an exemplary technical solution,
the elastic member is an elastic sheet, one end of the elastic sheet is fixed at a bottom of the groove, and the other end is a free end; the protruding portion is provided at the free end of the elastic sheet; when the clamping member squeezes the protruding portion, the protruding portion retreats; after the clamping member passes through the protruding portion, the protruding portion returns to the position before squeezed under the action of the elastic sheet.

In order to achieve the third purpose, the present utility model adopts a third technical solution as follows:

A chest expander, including pull ropes and a chest expander body,
the pull ropes or/and the chest expander body being equipped with the buckle connector above;
or the pull rope and the chest expander body being connected with each other through the buckle connector and other accessories.

### Beneficial Effect of the Present Utility Model

### Beneficial Effects

During use of the buckle connector provided in the present utility model, the male buckle is inserted into the female buckle from the opening, then the male buckle or female buckle is rotated to cause the clamping member to rotate in the groove, and then the clamping member is clamped through the horizontal groove in the female buckle, thus connecting the male buckle with the female buckle and achieving connection conveniently and easily. Since the elastic member is provided in the groove and the protruding portion is provided on the elastic member, when the clamping member rotates in the groove and passes through the protruding portion, it squeezes the protruding portion and then enters the groove, and then the protruding portion returns to an original position. In a case that no torque is applied externally to the male buckle, the protruding portion can prevent the clamping member from rotating in the groove, so that the connection between the male buckle and the female buckle is stable and reliable. When the buckle connector needs to be unfastened, a torque is applied to the male buckle to cause the clamping member to squeeze the protruding portion, so that the male buckle is separated from the female buckle.

Further, during use of the chest expander provided in the present utility model, the pull ropes and the chest expander body are connected with each other through the buckle connector, the male buckle is inserted into the female buckle from the opening, then the male buckle is rotated to cause the clamping member to rotate in the groove, and then the clamping member is clamped through the horizontal groove in the female buckle, thus connecting the male buckle with the female buckle and achieving connection conveniently and easily. Since the elastic member is provided in the groove and the protruding portion is provided on the elastic member, when the clamping member rotates in the groove and passes through the protruding portion, it squeezes the protruding portion and then enters the groove, and then the protruding portion returns to an original position. In a case that no torque is applied externally to the male buckle, the protruding portion can prevent the clamping member from rotating in the groove, so that the connection between the male buckle and the female buckle is stable and reliable. When the buckle connector needs to be unfastened, a torque is applied to the male buckle to cause the clamping member to squeeze the protruding portion, so that the male buckle is separated from the female buckle. By using the buckle connector to connect the chest expander body and the pull ropes, the pull ropes are fixed stably and reliably on the chest expander body, and it is very convenient to disassemble the pull ropes.

### BRIEF DESCRIPTION OF THE DRAWINGS

### Description of the Drawings

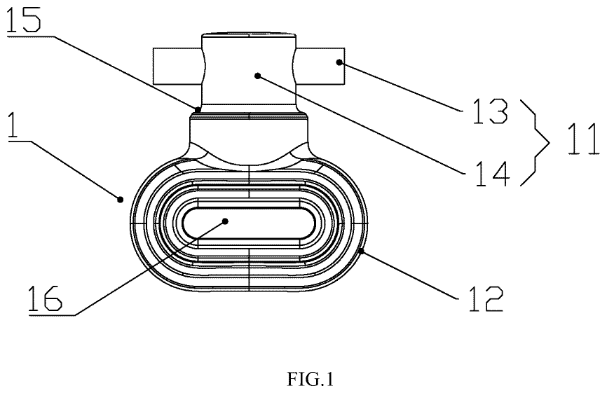

FIG. 1 illustrates a schematic diagram of a male buckle of a buckle connector according to the present utility model.

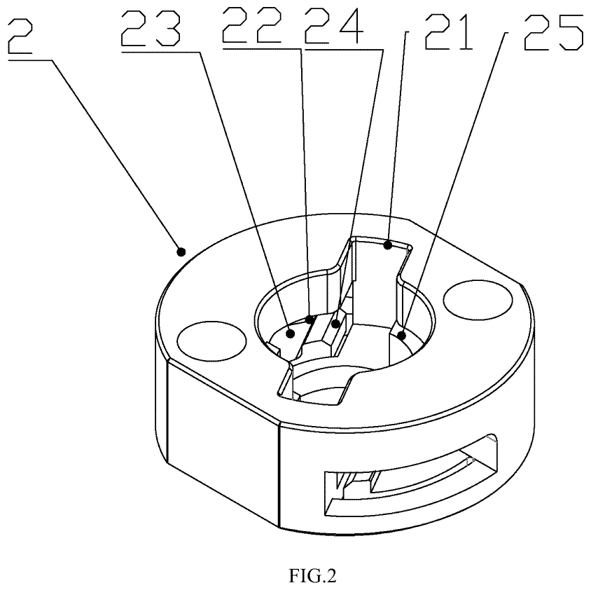

FIG. 2 illustrates a schematic diagram of a female buckle of a buckle connector according to the present utility model.

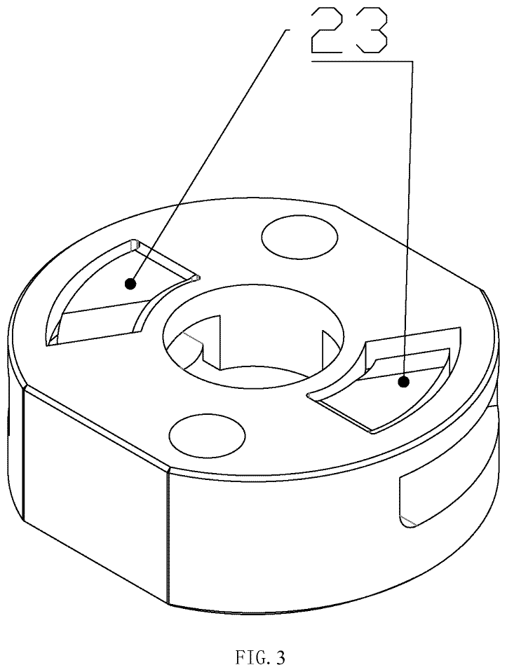

FIG. 3 illustrates a schematic diagram of a back side of a female buckle of a buckle connector according to the present utility model.

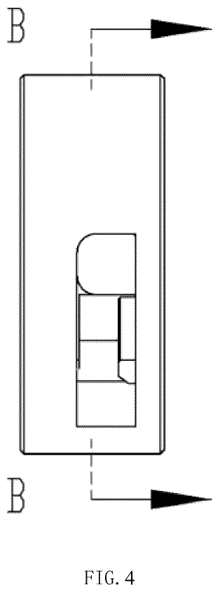

FIG. 4 illustrates a schematic diagram of a structure in FIG. 3 after rotation for a certain angle.

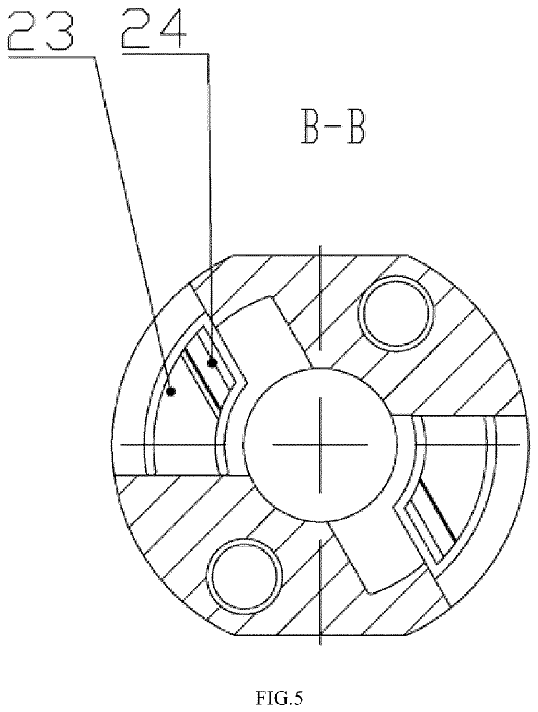

FIG. 5 illustrates a full cross-sectional schematic diagram of a female buckle in FIG. 4.

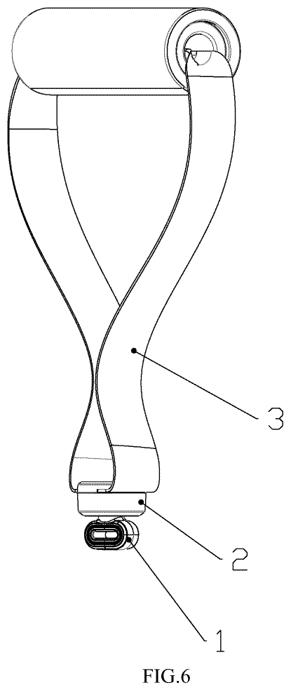

FIG. 6 illustrates a schematic diagram of a buckle connector applied to pull ropes according to the present utility model.

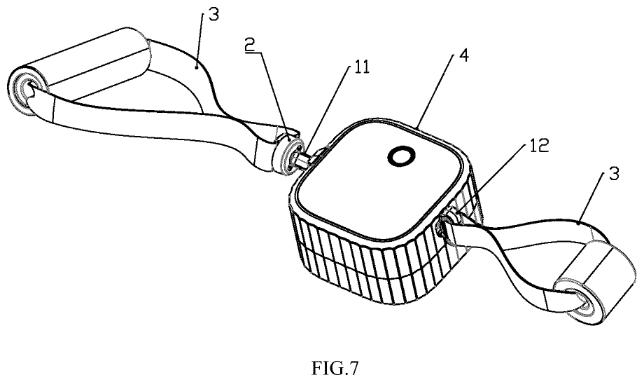

FIG. 7 illustrates a schematic diagram of a buckle connector applied to a chest expander according to the present utility model.

Description of reference signs: 1-male buckle; 11-connecting portion; 12-fixed portion; 13-clamping member; 14-insertion head; 15-recess; 16-through hole; 2-female buckle; 21-opening; 22-groove; 23-elastic sheet; 24-protruding portion; 25-protrusion; 3-pull rope; 4-chest expander body

### DETAILED DESCRIPTION OF THE EMBODIMENTS

### Description of the Embodiments

In order to make the purposes, technical solutions, and advantages of the present utility model clearer, the present utility model will be further described below in conjunction with the embodiments with reference to the drawings. It should be understood that the specific embodiments described here are only intended to describe the present utility model and are not intended to limit the present utility model.

On the contrary, the present utility model covers any replacements, modifications, equivalent methods, and solutions defined by the claims within the essence and scope of the present utility model. Further, in order to provide the public with a better understanding of the present utility model, specific details are described in detail in the following description of the present utility model. Those skilled in the art can fully understand the present utility model without the description of these details.

It should be noted that when two components are “clamped” or “fixedly connected” together, the two components may be directly connected or there may be an intermediate component. On the contrary, when a component is referred to as “directly on” another component, there is no intermediate component. The terms “inside”, “outside”, “up”, “down”, and similar expressions used herein are only for the purpose of description.

Unless otherwise defined, all technical and scientific terms used herein have the same meanings as those commonly understood by those skilled in the technical field of the present utility model. The terms used herein are only for the purpose of describing the specific embodiments and are not intended to limit the present utility model. The term “or/and” used herein includes any and all combinations of one or more related listed items.

As illustrated in FIGS. 1-5, specific embodiment of buckle connector according to the present utility model:

A buckle connector includes a male buckle 1 and a female buckle 2 rotatable relative to each other.

At least one clamping member 13 is provided on the male buckle 1.

The female buckle 2 is provided with an opening 21 for inserting the clamping member 13 and a groove 22 for allowing the clamping member 13 to rotate.

An elastic member is provided in the groove 22.

A protruding portion 21 for limiting the clamping member 13 is provided on the elastic member.

When a torque is applied to the male buckle 1 so that the clamping member 13 rotates in the groove 22 and passes through the protruding portion 24, the clamping member 13 squeezes the protruding portion 24 and causes it to retreat to allow the clamping member 13 to pass through.

After the clamping member 13 passes through the protruding portion 24 the protruding portion 24 returns to a position before squeezed to complete the operation of locating the male buckle 1 on the female buckle 2.

During use of the buckle connector provided in the present utility model, the male buckle 1 is inserted into the female buckle 2 from the opening 21, then the male buckle 1 or female buckle 2 is rotated to cause the clamping member 13 to rotate in the groove 22. Since the elastic member is provided in the groove 22 and the protruding portion 24 is provided on the elastic member, when the clamping member 13 rotates in the groove 22 and passes through the protruding portion 24, it squeezes the protruding portion 24 and then enters the groove 22, and then the protruding portion 24 returns to an original position. In a case that no torque is applied externally to the male buckle 1, the protruding portion 24 can prevent the clamping member 13 from rotating in the groove 22, so that the connection between the male buckle 1 and the female buckle 2 is stable and reliable. When the buckle connector needs to be unfastened, a torque is applied to the male buckle 1 to cause the clamping member 13 to squeeze the protruding portion 24, so that the male buckle 1 is separated from the female buckle 2. The solution is simple, practical and feasible, and facilitates the production, manufacturing, promotion and use.

Specific embodiment of clamping member 13 according to the present utility model:

The clamping member 13 is a columnar structure, a spherical structure, or a cubic structure subjected to chamfering treatment, extends outwards from a main body of the male buckle 1, and forms a protruding wing-shaped body.

The opening 21 is in a shape fit with the shape of the clamping member 13.

Specific embodiment of recessed structure additionally provided according to the present utility model:

The groove 22 is provided with a recessed portion at a position fit with the protruding portion 24.

The recessed portion is provided on a bottom wall or side wall of the groove 22, is provided with the elastic member inside, is capable of accommodating the protruding portion 24, and forms a retreating space for the protruding portion 24, so the structure is simple and practical, and the solution is feasible.

The most preferred embodiment of buckle connector according to the present utility model:

A buckle connector includes a male buckle 1 and a female buckle 2 fit with each other. The male buckle 1 includes a connecting portion 11. The connecting portion 11 includes a clamping member 13. The female buckle 2 is provided with an opening 21 for inserting the clamping member 13. The opening 21 extends towards the interior of the female buckle 2 and forms a groove 22 for fixing the clamping member 13 along a circumferential direction. An elastic member is provided in the groove 22. A protruding portion 24 for preventing the clamping member 13 from passing through is provided on the elastic member. When the clamping member 13 rotates in the groove 22 and passes through the protruding portion 24, the clamping member 13 squeezes the protruding portion 24 and causes the protruding portion 24 to retreat to allow the clamping member 13 to pass through. After the clamping member 13 passes through the protruding portion 24, the protruding portion 24 returns to a position before squeezed.

Specific embodiment of elastic sheet 23 as elastic member according to the present utility model:

The elastic member is an elastic sheet 23. One end of the elastic sheet 23 is fixed at a bottom of the groove 22, and the other end is a free end. The protruding portion 24 is provided at the free end of the elastic sheet 23. When the clamping member 13 squeezes the protruding portion 24, the protruding portion 24 retreats. After the clamping member 13 passes through the protruding portion 24, the protruding portion 24 returns to the position before squeezed under the action of the elastic sheet 23. By providing the elastic sheet 23 at the bottom of the groove 22 to achieve the function of the elastic member, the structure is simple and the cost is low.

Specific embodiment of protrusion 25 and recess structures according to the present utility model:

A protrusion 25 is provided in the opening 21. A recess 15 fit with the protrusion 25 is provided on the connecting portion 11. The protrusion 25 is abutted against the recess 15 when the connecting portion 11 is inserted into the opening 21. By providing the protrusion 25 and the recess 11 fit with each other, the structure of the female buckle 2 can be prevented from being damaged because the force in the axial direction is too large when the male buckle 1 is inserted into the female buckle 2.

Specific embodiment of male buckle 1 structure according to the present utility model:

The connecting portion 11 includes an insertion head 14. The clamping member 13 is cylindrical. The clamping member 13 is symmetrically provided at the end of the insertion head 14. The opening 21 is in a shape fit with the connecting portion 11. Since the clamping member 13 is cylindrical, it is easier and more labor-saving when it passes through the protruding portion 24. Since the clamping member 13 is symmetrically provided on the insertion head 14, the stress is more even during the connection between the male buckle 1 and the female buckle 2.

The male buckle 1 further includes a fixed portion 12 fixedly connected with the connecting portion 11. The fixed portion 12 is provided with a through hole 16. The through hole 16 provided in the fixed portion 12 is used for fixing parts such as pull ropes 3.

Specific embodiment of female buckle 2 structure according to the present utility model:

The female buckle 2 is an arc-shaped structure, is provided with a groove 22 along a periphery in the female buckle 2, and is provided with an opening 21 communicated with the groove 22 and an insertion opening in a surface of the female buckle 2, so that the male buckle 1 can be inserted into the female buckle 2 and can rotate in the groove 22.

As illustrated in FIG. 6, specific embodiment of buckle connector applied to pull ropes 3 according to the present utility model:

A chest expander includes pull ropes 3 and a chest expander body 4.

The pull ropes 3 are equipped with the buckle connector and are connected with other accessories through the buckle connector.

As illustrated in FIG. 7, it illustrates a schematic diagram of a buckle connector applied to a chest expander according to the present utility model.

A chest expander includes pull ropes 3 and a chest expander body 4.

The number of the pull ropes 3 is two. The two pull ropes 3 are respectively connected with the chest expander body 4 through the buckle connector described above, so as to facilitate the rapid separation of the pull ropes 3 from the chest expander body 4.

Finally, it should be noted that the above embodiments are only intended to describe the technical solutions of the present utility model, instead of limiting the present utility model. Although the present utility model has been described in detail with reference to the above embodiments, those skilled in the art should understand that the specific embodiments of the present utility model may still be modified or equivalently replaced. Any modifications or equivalent replacements that do not deviate from the spirit and scope of the present utility model should be all included within the scope of protection of the claims of the present utility model.

1. A buckle connector, comprising a male buckle (1) and a female buckle (2) fit with each other, the male buckle (1) comprising a connecting portion (11), the connecting portion (11) comprising a clamping member (13); the female buckle (2) being provided with an opening (21) for inserting the clamping member (13), the opening (21) extending towards the interior of the female buckle (2) and forming a groove (22) for accommodating the clamping member (13) along a circumferential direction, an elastic member being provided in the groove (22), a protruding portion (24) for preventing the clamping member (13) from passing through being provided on the elastic member; when a torque is applied to the male buckle (1) so that the clamping member (13) rotates in the groove (22) and passes through the protruding portion (24), the clamping member (13) squeezing the protruding portion (24) and causing the protruding portion (24) to retreat to allow the clamping member (13) to pass through; after the clamping member (13) passes through the protruding portion (24), the protruding portion (24) returning to a position before squeezed.

2. The buckle connector according to claim 1, wherein the elastic member is an elastic sheet (23), one end of the elastic sheet (23) is fixed at a bottom of the groove (22), and the other end is a free end; the protruding portion (24) is provided at the free end of the elastic sheet (23); when the clamping member (13) squeezes the protruding portion (24), the protruding portion (24) retreats; after the clamping member (13) passes through the protruding portion (24), the protruding portion (24) returns to the position before squeezed under the action of the elastic sheet (23).

3. The buckle connector according to claim 2, wherein a protrusion (25) is provided in the opening (21), a recess (15) fit with the protrusion (25) is provided on the connecting portion (11), and the protrusion (25) is abutted against the recess (15) when the connecting portion (11) is inserted into the opening (21).

4. The buckle connector according to any one of claims 1-3, wherein the connecting portion (11) comprises an insertion head (14), the clamping member (13) is cylindrical, the clamping member (13) is symmetrically provided at the end of the insertion head (14), and the opening (21) is in a shape fit with the connecting portion (11).

5. The buckle connector according to claim 4, wherein the male buckle (1) further comprises a fixed portion (12) fixedly connected with the connecting portion (11), and the fixed portion (12) is provided with a through hole (16).

6. A buckle connector, comprising:
a male buckle (1) and a female buckle (2) rotatable relative to each other;
at least one clamping member (13) being provided on the male buckle (1);
the female buckle (2) being provided with an opening (21) for inserting the clamping member (13) and a groove (22) for allowing the clamping member (13) to rotate;
an elastic member being provided in the groove (22);
a protruding portion (24) for limiting the clamping member (13) being provided on the elastic member;
when a torque is applied to the male buckle (1) so that the clamping member (13) rotates in the groove (22) and passes through the protruding portion (24), the clamping member (13) squeezing the protruding portion (24) and causing the protruding portion (24) to retreat to allow the clamping member (13) to pass through;
after the clamping member (13) passes through the protruding portion (24), the protruding portion (24) returning to a position before squeezed to complete the operation of locating the male buckle (1) on the female buckle (2).

7. The buckle connector according to claim 6, wherein the clamping member (13) is a cylindrical or spherical structure or a square structure subjected to chamfering treatment, and extends outwards from a main body of the male buckle (1) to form a protruding wing-shaped body;
the opening (21) is in a shape fit with the shape of the clamping member (13).

8. The buckle connector according to claim 6, wherein the groove (22) is provided with a recessed portion at a position fit with the protruding portion (24);
the recessed portion is provided on a bottom wall or side wall of the groove (22), is provided with the elastic member inside, is capable of accommodating the protruding portion (24), and forms a retreating space for the protruding portion (24);
the elastic member is a spring, a rubber body, a torsion spring, or an elastic sheet (23).

9. The buckle connector according to any one of claims 6-8, wherein the elastic member is an elastic sheet (23), one end of the elastic sheet (23) is fixed at a bottom of the groove (22), and the other end is a free end; the protruding portion (24) is provided at the free end of the elastic sheet (23); when the clamping member (13) squeezes the protruding portion (24), the protruding portion (24) retreats; after the clamping member (13) passes through the protruding portion (24), the protruding portion (24) returns to the position before squeezed under the action of the elastic sheet (23).

10. A chest expander, comprising pull ropes (3) and a chest expander body (4), the pull ropes (3) or/and the chest expander body (4) being equipped with the buckle connector according to any one of claims 1-9.
